(19) United States
(12) Patent Application Publication
(10) Pub. No.: US 2017/0361557 A1
(43) Pub. Date: Dec. 21, 2017

(54) TIRE HAVING AN OVER-MOLDED BEAD CONSTRUCTION

(71) Applicant: Bridgestone Americas Tire Operations, LLC, Nashville, TN (US)

(72) Inventors: David J. Zemla, Canal Fulton, OH (US); Jon I. Stuckey, Uniontown, OH (US)

(21) Appl. No.: 15/532,513

(22) PCT Filed: Dec. 2, 2015
(86) PCT No.: PCT/US15/63366

§ 371 Date: Jun. 2, 2017

Related U.S. Application Data
(60) Provisional application No. 62/092,301, filed on Dec. 16, 2014.

(51) Int. Cl. B29D 30/48; B60C 15/06; B60C 15/05; B60C 15/04; B60C 1/00

(52) U.S. Cl. CPC B29D 30/48; B60C 15/05; B60C 15/04; B60C 15/0607; B29D 2030/482; B60C 2001/0058

(57) ABSTRACT

A pneumatic tire having a bead filler molded over a bead bundle to form an over-molded bead. The bead bundle may include at least one bead wire. The bead bundle may be over-molded with the bead filler, forming an over-molded bead. The over-molded bead may be formed into a variety of shapes and may be constructed from a variety of materials.

### BACKGROUND

In the construction of a pneumatic tire, one of the many key elements is a bead, which typically comprises individual bead wires wound into a bundle of a desired diameter and configuration prior to tire assembly. The bead, also known as a bead bundle, may help to anchor the inflated tire to a wheel rim. A tire may include a bead bundle on each of an inboard portion and an outboard portion of the tire, with each inboard and outboard portion being positioned to engage the corresponding inboard and outboard flanges of a wheel.

A tire may also include at least one body ply. The body ply, which typically comprises reinforcement cord and rubber skim, wraps around the bead bundle (creating a “turnup” portion), passes axially across the tire, and wraps around the bead bundle on the opposite side (creating another “turnup” portion). The portion of body ply adjacent to the bead bundle on the inner portion of the tire (i.e. opposite the turnup) may be referred to as the inner body ply. The body ply may provide strength to contain the air pressure within the tire and may provide sidewall impact resistance. A tire may include one or more body plies to achieve the desired degree of strength and sidewall impact resistance.

A tire may also include a bead filler applied to the top of the bead bundle to fill the void between the inner body ply and the body ply turnup. The bead filler, also known as an apex, may be configured with various properties. Such properties may include, without limitation, height, width, and hardness. Changing the properties of the bead filler may affect the ride and handling characteristics of the tire, such as, without limitation, sidewall stiffness, noise, and rolling resistance.

When constructing a tire, tire manufacturers may choose various configurations of bead bundles and bead fillers. The bead filler and the bead bundle may be assembled simultaneously with the tire. Alternatively, the bead filler may be preassembled onto the bead bundle before tire assembly.

When a tire is assembled, the one or more body plies, together with other tire components such as an innerliner, may be rolled down over a rotating, collapsible drum. The bead wire and bead filler, or alternatively the preassembled bead wire and bead filler assembly, may be set into place around the drum. The edges of the one or more body plies may then be turned-up around each bead bundle and bead filler and rolled or stitched to the flat portion of the body plies, thereby creating the body ply turnups. The drum may then be collapsed so that the completed body carcass may be removed for further assembly stages.

The tire manufacturing process described above may have certain drawbacks. For example, after the bead bundle and bead filler are assembled with the tire, the positions of the bead bundle, the bead filler, and the body ply may move relative to one another. When the tire is cured, any such movements may result in tire uniformity irregularities. Such irregularities may result in, for example, tire imbalance, ineffective sealing between the bead of the tire and the flange of the wheel, high stress points within the tire structure, and weakness within the tire structure. Additionally, the current tire manufacturing process may not allow for significant control over other aspects of tire design and construction, such as ride and handling characteristics, and weight. What is needed is a bead bundle and a bead filler that can be more uniformly assembled with other tire components to reduce or eliminate these drawbacks.

### SUMMARY

In one embodiment, an over-molded bead for a pneumatic tire may have a bead bundle having at least one of: a bead wire, a fabric reinforcement, and a polymer; and a bead filler molded about the bead bundle so as to at least substantially encapsulate the bead bundle within the bead filler. In one embodiment, the molded bead filler may fully encapsulate the bead bundle.

In another embodiment, a bead for a pneumatic tire may have a bead bundle having at least one of: a bead wire, a fabric reinforcement, and a polymer; and a molded bead filler, wherein the outer surface of the radially inward portion of the molded bead filler may be contoured to mate with the outer surface of the radially outward portion of the bead bundle. At least one of the bead bundle and the molded bead filler may be configured to be operatively connected to the other so as to collectively form an integrated unit. The outer surface of the bead bundle and the outer surface of the molded bead filler may have at least one of a surface feature, wherein the at least one surface feature may have at least one of a protrusion and an indentation, and wherein the at least one surface feature of the bead bundle may be configured to mate with the at least one surface feature of the molded bead filler. The molded bead filler may have at least one surface feature. The at least one surface feature may have at least one of: a dimple, an indentation, a ridge, a slit, a knurl, a cavity, a recess, a cut-out, and a step. The molded bead filler may include a polymer. The polymer may have a hardness of about 75 durometer or lower. The polymer may have a hardness of about 75 durometer or higher. The molded bead filler may have a fabric reinforcement, wherein the fabric reinforcement may be oriented in at least one of: an interior of the molded bead filler and an exterior surface of the molded bead filler. The bead bundle may have at least one of: a single bead wire, at least two adjacently-oriented bead wires, a plurality of bead wires arranged in a grid array, a plurality of bead wires arranged in an offset grid array, a plurality of bead wires arranged in a radial array, and a plurality of bead wires arranged in at least one linear array. The bead wire may have at least one of: a bronze, a brass, a steel, a nylon, a polyester, a rayon, an aramid fiber, a carbon fiber, a fiberglass, and an alloy.

In another embodiment, a pneumatic tire may have a bead bundle having at least one of: a bead wire, a fabric reinforcement, and a polymer; and a bead filler molded about the bead bundle so as to at least substantially encapsulate the bead bundle within the molded bead filler. The molded bead filler may fully encapsulate the bead bundle. The bead bundle may have a bead wire, wherein the bead wire is at least one of: molded onto an exterior surface of the molded bead filler, and applied to the surface of the molded bead filler. The molded bead filler may have at least one surface feature. The at least one surface feature may have at least one of: a dimple, an indentation, a ridge, a slit, knurl, a cavity, a recess, a cut-out, and a step. The molded bead filler may include a polymer. The molded bead filler may have a fabric reinforcement, wherein the fabric reinforcement may be oriented in at least one of: an interior of the molded bead filler and an exterior surface of the molded bead filler. The molded bead bundle may have at least one of: a single bead wire, at least two adjacently-oriented bead wires, a plurality of bead wires arranged in a grid array, a plurality of bead wires arranged in an offset grid array, a plurality of bead wires arranged in a radial array, and a plurality of bead wires arranged in at least one linear array. The bead wire may have at least one of: a bronze, a brass, a steel, a nylon, a polyester, a rayon, an aramid fiber, a carbon fiber, a fiberglass, and an alloy.

### BRIEF DESCRIPTION OF THE DRAWINGS

The accompanying figures, which are incorporated in and constitute a part of the specification, illustrate various example apparatuses and systems, and are used merely to illustrate various example embodiments. In the figures, like elements bear like reference numerals.

FIG. 1 illustrates a sectional view of an example arrangement of a tire having an over-molded bead construction.

FIG. 2 illustrates a sectional view of an example arrangement of a prior art tire construction.

FIG. 3 illustrates a sectional view of an example arrangement of an over-molded bead construction.

FIG. 4 illustrates a sectional view of an example arrangement of an over-molded bead construction.

FIG. 5 illustrates a sectional view of an example arrangement of an over-molded bead construction.

FIG. 6A illustrates a sectional view of an example arrangement of an over-molded bead construction.

FIG. 6B illustrates a sectional view of an example arrangement of an over-molded bead construction.

FIG. 7 illustrates a sectional view of an example arrangement of a two-piece over-molded bead construction.

FIG. 8 illustrates a sectional view of an example arrangement of a two-piece over-molded bead construction.

FIG. 9 illustrates a sectional view of an example arrangement of an over-molded bead construction.

FIG. 10 illustrates a sectional view of an example arrangement of an over-molded bead construction.

FIG. 11 illustrates a sectional view of an example arrangement of an over-molded bead construction.

### DETAILED DESCRIPTION

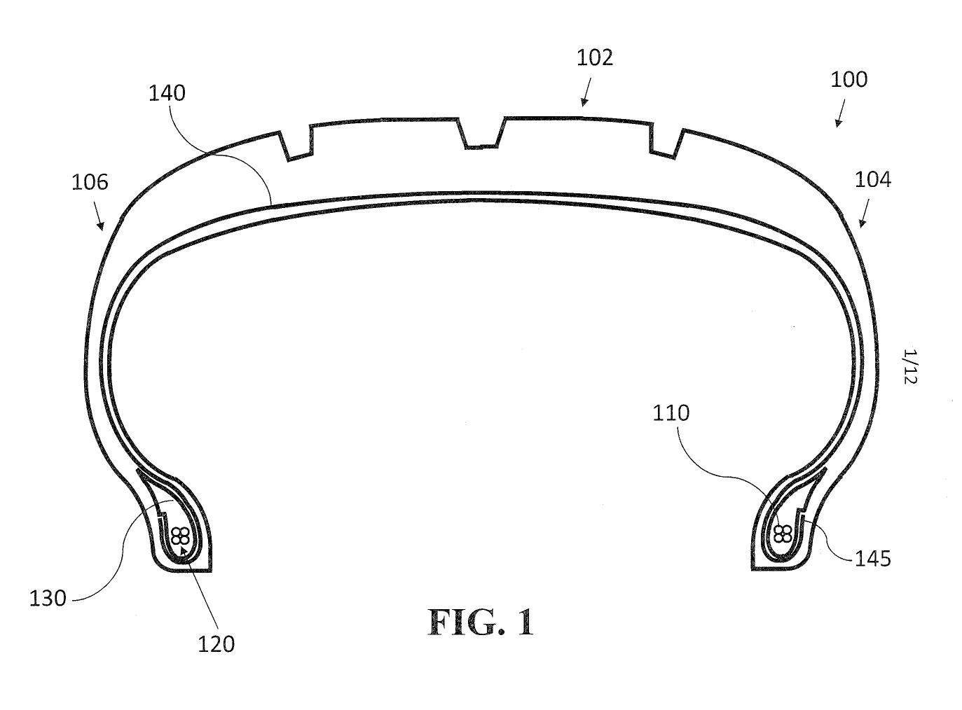

FIG. 1 illustrates a sectional view of an example arrangement of tire 100 having an over-molded bead construction. Tire 100 may include at least one bead wire 110 located on each of inboard side 104 and outboard side 106. Tire 100 may also include a bead bundle 120 having at least one bead wire 110. Tire 100 may also include a bead filler 130, which may include bead bundle 120. Tire 100 may also include at least one of a body ply 140, which may extend axially outward from crown portion 102 to each of inboard side 104 and outboard side 106. Body ply 140 may extend radially inward from crown portion 102. Body ply 140 may turn about at least one of bead bundles 120 and extend radially outward, forming a body ply turnup 145 on at least one of inboard side 104 and outboard side 106 of tire 100.

Tire 100 may be a pneumatic tire. Tire 100 may be a pneumatic tire designed for application to a vehicle. Tire 100 may be a pneumatic tire designed for application to an off-the-road vehicle. Tire 100 may be a pneumatic tire designed for application to a road vehicle. Tire 100 may be a non-directional tire, wherein tire 100 is configured to be mounted on a vehicle without a specified forward rolling direction. Tire 100 may be a uni-directional tire, wherein tire 100 is configured to be mounted on a vehicle with a specified forward rolling direction. Tire 100 may include a crown portion 102. Tire 100 may include a designated inboard side 104 and a designated outboard side 106, such that when mounted on a vehicle, inboard side 104 is always oriented toward the centroid of the vehicle, while outboard side 106 is always oriented away from the centroid of the vehicle. Tire 100 may include no designated inboard or outboard side, but rather may have two sides that are substantially similar to one another.

Bead wire 110 may be made from any of a variety of materials. For example, bead wire 110 may be made from a steel. Bead wire 110 may be coated in a bronze to aid in adhesion to a rubber or other polymer. Bead wire 110 may be made from other materials, including a brass, a nylon, a polyester, a rayon, an aramid fiber, a carbon fiber, a fiberglass, an alloy, and the like. Bead wire 110 may be made from any material that provides the desired physical properties, including without limitation, strength, stiffness, hardness, weight, fatigue resistance, flexibility, heat resistance, cost, and the like.

Tire 100 may include at least one bead wire 110 arranged in various configurations to form bead bundle 120. For example, bead wires 110 may be arranged as any of: a single bead wire 110, at least two adjacently-oriented bead wires 110, a plurality of bead wires 110 arranged in a grid array, a plurality of bead wires 110 arranged in an offset grid array, a plurality of bead wires 110 arranged in a radial array, a plurality of bead wires 110 arranged in at least one linear array, and the like. Bead bundle 120 may include at least one of: a bead wire 110, a fabric reinforcement (not shown), and a polymer (not shown). Bead bundle 120 may be located in inboard side 104 of tire 100. Bead bundle 120 may also be located in outboard side 106 of tire 100. Bead bundle 120 located in inboard side 104 may be either identical to or different from bead bundle 120 located in outboard side 106.

Tire 100 may include at least one bead filler 130. Bead filler 130 may be located in inboard side 104 of tire 100. Bead filler 130 may be located in outboard side 106 of tire 100. Bead filler 130 may be located in both of inboard side 104 and outboard side 106 of tire 100. Bead filler 130 located in inboard side 104 may be either identical to or different from bead filler 130 located in outboard side 106.

Bead filler 130 may include at least one bead bundle 120. Bead filler 130 may be made from a polymer. Bead filler 130 may be made from any material that provides the desired physical properties, including without limitation, strength, stiffness, hardness, weight, fatigue resistance, flexibility, heat resistance, cost, and the like. Bead filler 130 may have a hardness of about 75 durometer. Bead filler 130 may have a hardness of about 75 durometer or lower. Bead filler 130 may have a hardness of about 75 durometer or higher. Bead filler 130 may have a desired stiffness so as to control the ride quality and handling of tire 100.

Bead filler 130 may be molded over bead bundle 120 to form an integrated unit. Bead filler 130 may completely encapsulate bead bundle 120. Bead filler 130 may substantially encapsulate bead bundle 120. Bead filler 130 may sufficiently encapsulate bead bundle 120 so as to form an integrated unit.

Bead filler 130 may be molded into a variety of shapes. For example, bead filler 130 may be molded into a wedge shape. Bead filler 130 may be molded into an irregular shape. Bead filler 130 may be molded into any shape that aids in the integration of bead filler 130 and bead bundle 120. Bead filler 130 may be molded into any shape that reduces stress risers in tire 100. For example, bead filler 130 may be molded into a shape that allows body ply turnup 145 to terminate flush against either of bead filler 130 or body ply 140.

Bead filler 130 may include surface features (not shown) that increase the coefficient of friction between bead filler 130 and at least one of body ply 140 and body ply turnup 145. These surface features may also include at least one void space to allow the end of body ply turnup 145 to nest within bead filler 130. Surface features may include, without limitation, a dimple, an indentation, a ridge, a slit, a knurl, a cavity, a recess, a cut-out, and a step.

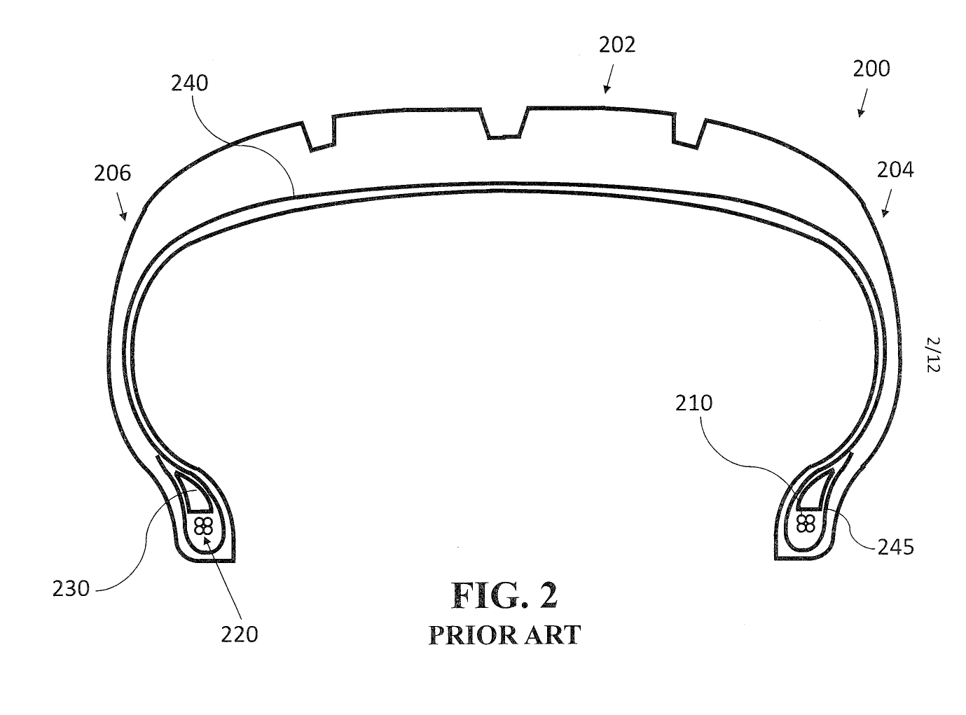

FIG. 2 illustrates a sectional view of an example arrangement of tire 200 having a prior art construction. Tire 200 may include at least one bead wire 210 located on each of inboard side 204 and outboard side 206. Tire 200 may also include a bead bundle 220 having at least one bead wire 210. Tire 200 may also include a bead filler 230, which may include bead bundle 220. Tire 200 may also include at least one body ply 240, which may extend axially outward from crown portion 202 to each of inboard side 204 and outboard side 206. Body ply 240 may extend radially inward from crown portion 202. Body ply 240 may turn about each bead bundle 220 and extend radially outward, forming a body ply turnup 245 on each of inboard side 204 and outboard side 206 of tire 200.

Bead filler 230 does not include bead bundle 220. Rather, bead filler 230 and bead bundle 220 are separate structures. This arrangement may result in several disadvantages. The end of body ply turnup 245 may not properly or consistently align with either of bead bundle 220, bead filler 230, or body ply 240, which may create an imbalance in tire 200. Furthermore, bead bundle 220 and bead filler 230 may drift apart, which may cause further imbalances in tire 200. Moreover, relative movement among bead bundle 220, bead filler 230, and body ply 240 may cause a weakness in tire 200 due to either an insufficient amount of material or an abundance of material at any given location. Insufficient material, which may occur when bead bundle 220 and bead filler 230 drift apart, may result in a weakness at that location Likewise, an abundance of material, which may occur when body ply turnup 245 moves relative to bead filler 230, may result in a stress riser at that location. A stress riser may occur when the end of body ply turnup 245 does not transition smoothly into body ply 240. When this happens, the resulting step between body ply 240 and body ply turnup 245 may create a location of high stress, which may result in early failure of body ply 240 at that location. Additionally, bead bundle 220 may need to be of sufficient stiffness to facilitate forming a round hoop when building tire 200. This limits a tire designer's freedom of choice of materials for bead wire 210, which in turn may limit the tire designer's ability to tailor the desired ride quality and handling of tire 200.

By contrast, tire 100 and its over-molded bead construction may avoid at least one or more or the disadvantages described above. Bead bundle 120 may be formed by the desired number and arrangement of bead wire 110. Bead bundle 120 may be over-molded within bead filler 130 to form an over-molded bead as a single integrated unit. Because bead filler 130 is molded, it need not rely on the stiffness of bead bundle 120 to provide its round hoop shape. This may allow the tire designer to choose from a wider variety of materials and configurations for bead bundle 120 and bead filler 130, which in turn may result in greater control for the tire designer over the ride quality and handling of tire 100. For example, the tire designer may select materials that provide proper bead stiffness when tire 100 is mounted on a vehicle, and need not select materials based on the stiffness necessary to construct tire 100. Furthermore, tire 100 may be constructed either symmetrically or asymmetrically with respect to at least one of bead bundle 120 and bead filler 130.

Furthermore, molding bead bundle 120 within bead filler 130 may eliminate the possibility of bead bundle 120 and bead filler 130 drifting apart or shifting during the tire construction process. This may result in higher uniformity of tire 100 and thus more predictable and reliable ride quality and handling of tire 100. Moreover, bead filler 130 may include at least one surface feature (not shown), including without limitation, a dimple, an indentation, a ridge, a slit, a knurl, a cavity, a recess, a cut-out, a step, and the like. The surface feature may allow body ply 140 and body ply turnup 145 to positively engage with bead filler 130 during the construction process, so that when body ply turnup 145 is formed and the drum is collapsed, the engagement between bead filler 130, body ply 140, and body ply turnup 145 may prevent the three components from moving relative to one another. This may further contribute to higher uniformity of tire 100 when compared to prior art tire 200.

The surface feature may include a void that allows the end of body ply turnup 145 to nest within bead filler 130. Nesting the end of body ply turnup 145 within bead filler 130 may contribute to a reduction or elimination of stress risers within tire 100 and may further prevent the relative movement of bead filler 130, body ply 140, and body ply turnup 145 during construction of tire 100. Nesting the end of body ply turnup 145 within bead filler 130 may allow for body ply turnup 145 to be created with a lower height because body ply turnup 145 need not extend beyond bead filler 130. As a result, bead filler 130 may be extended radially outward from bead bundle 120 past the radially outermost end of body ply turnup 145. Bead filler 130 may extend radially outward from bead bundle 120 into the sidewall portion of tire 100. Bead filler 130 may extend radially outward from bead bundle 120 into the shoulder portion of tire 100. Bead filler 130 may extend radially outward from bead bundle 120 into crown portion 102. Bead filler 130 may extend radially outward from bead bundle 120 across crown portion 102.

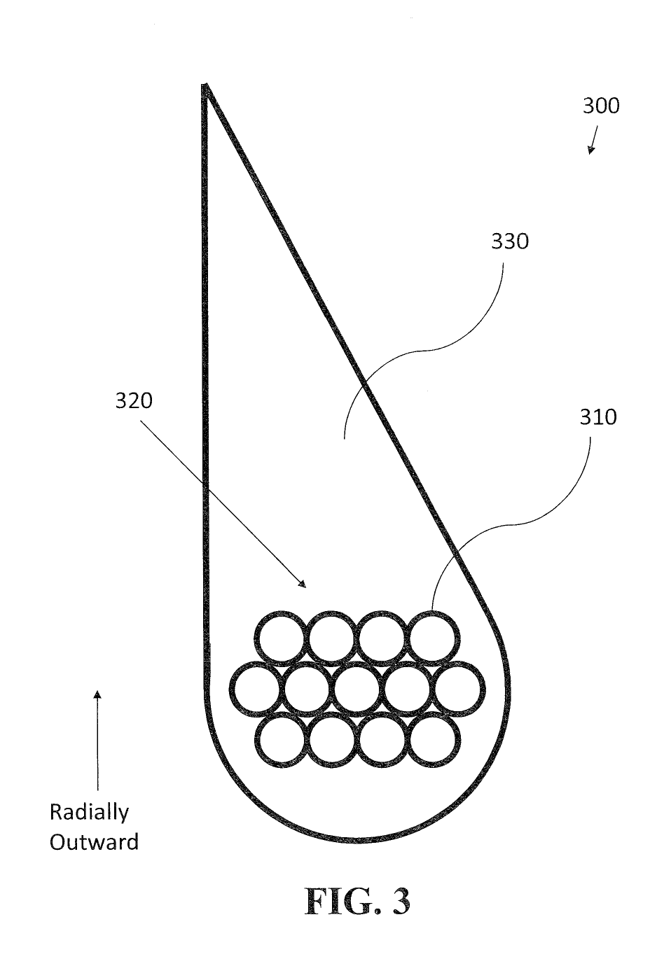

FIG. 3 illustrates a sectional view of an example arrangement of an over-molded bead 300. Bead wire 310 may be arranged in an offset grid-array arrangement to form bead bundle 320 (as shown). Bead wire 310 may be arranged in any of a variety of arrangements. Bead wire 310 may be arranged in any manner that meets the tire design requirements, such as, without limitation, strength, stiffness, hardness, weight, fatigue resistance, flexibility, heat resistance, cost, and the like. Bead filler 330 may be molded over bead bundle 320 to form over-molded bead 300. Bead filler 330 may at least substantially encapsulate bead bundle 320 within bead filler 330. Bead filler 330 may fully encapsulate bead bundle 320. Over-molded bead 300 may form a variety of shapes, such as the particular wedge shape as shown in FIG. 3.

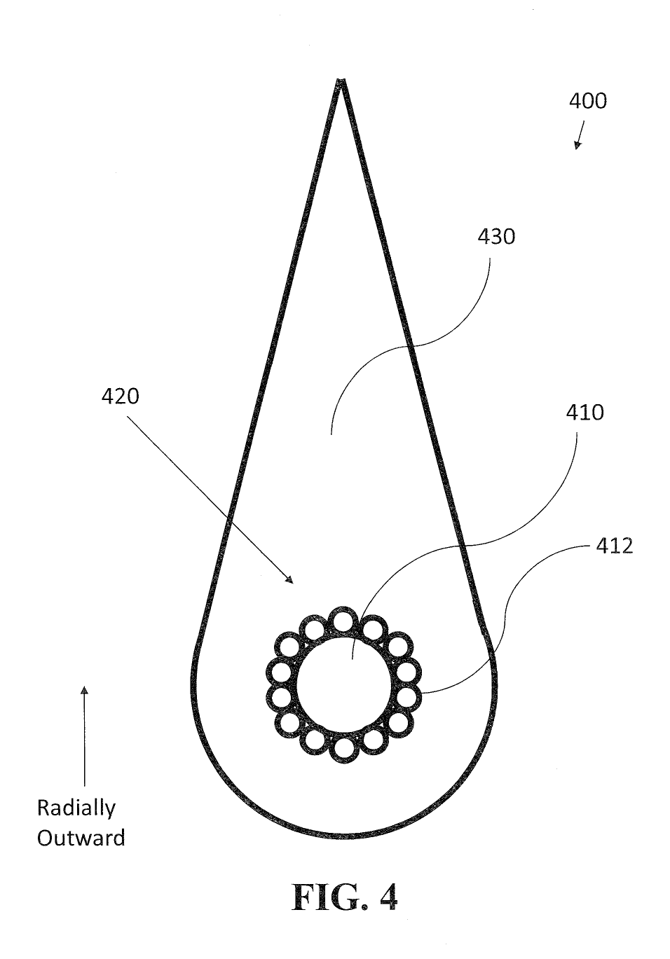

FIG. 4 illustrates a sectional view of an example arrangement of an over-molded bead 400. Bead wire 410 may be arranged with a central bead wire 410 that is surrounded by a radial array of bead wires 412 to form bead bundle 420 (as shown). Bead wires 410,412 may be arranged in any manner that meets the tire design requirements, such as, without limitation, strength, stiffness, hardness, weight, fatigue resistance, flexibility, heat resistance, cost, and the like. Bead filler 430 may be molded over bead bundle 420 to form over-molded bead 400. Bead filler 430 may at least substantially encapsulate bead bundle 420 within bead filler 430. Bead filler 430 may fully encapsulate bead bundle 420. Over-molded bead 400 may form a variety of shapes, such as the particular wedge shape as shown in FIG. 4.

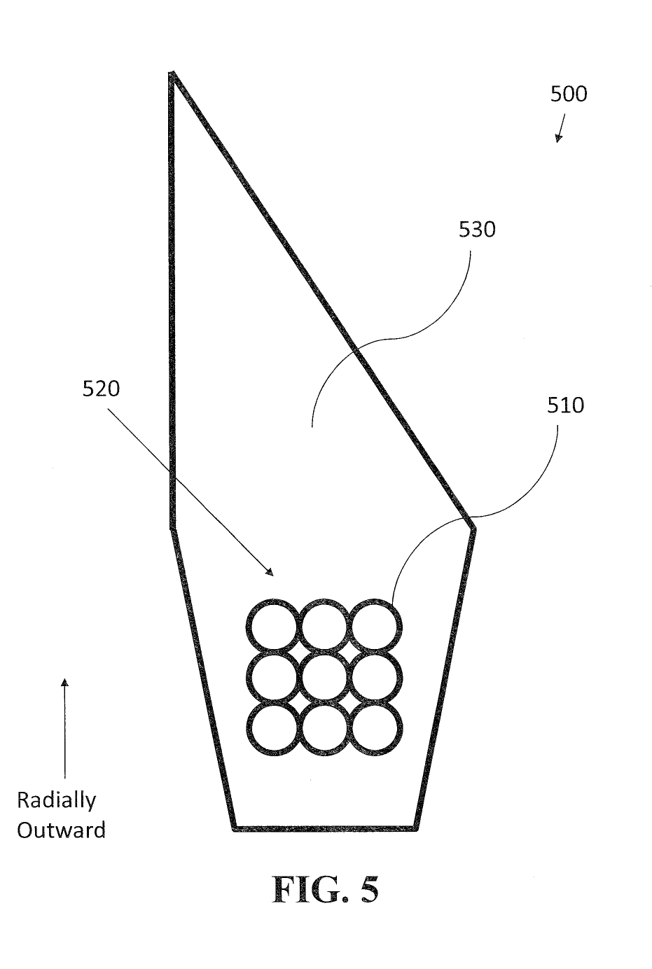

FIG. 5 illustrates a sectional view of an example arrangement of an over-molded bead 500. Bead wire 510 may be arranged in a grid array arrangement to form bead bundle 520 (as shown). Bead wire 510 may be arranged in any manner that meets the tire design requirements, such as, without limitation, strength, stiffness, hardness, weight, fatigue resistance, flexibility, heat resistance, and cost. Bead filler 530 may be molded over bead bundle 520 to form over-molded bead 500. Bead filler 530 may at least substantially encapsulate bead bundle 520 within bead filler 530. Bead filler 530 may fully encapsulate bead bundle 520. Over-molded bead 500 may form a variety of shapes, such as the particular wedge shape as shown in FIG. 5.

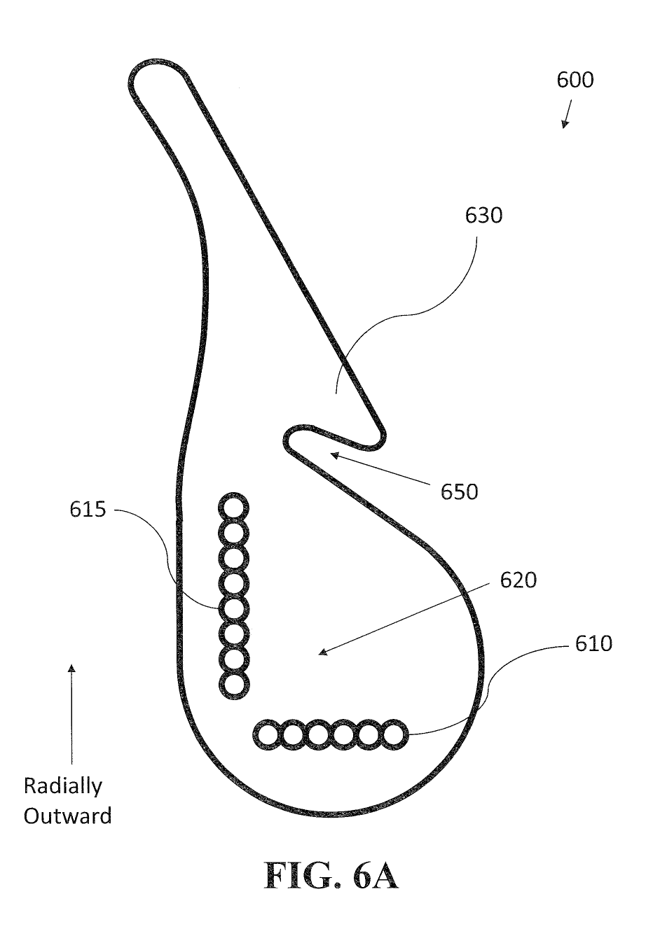

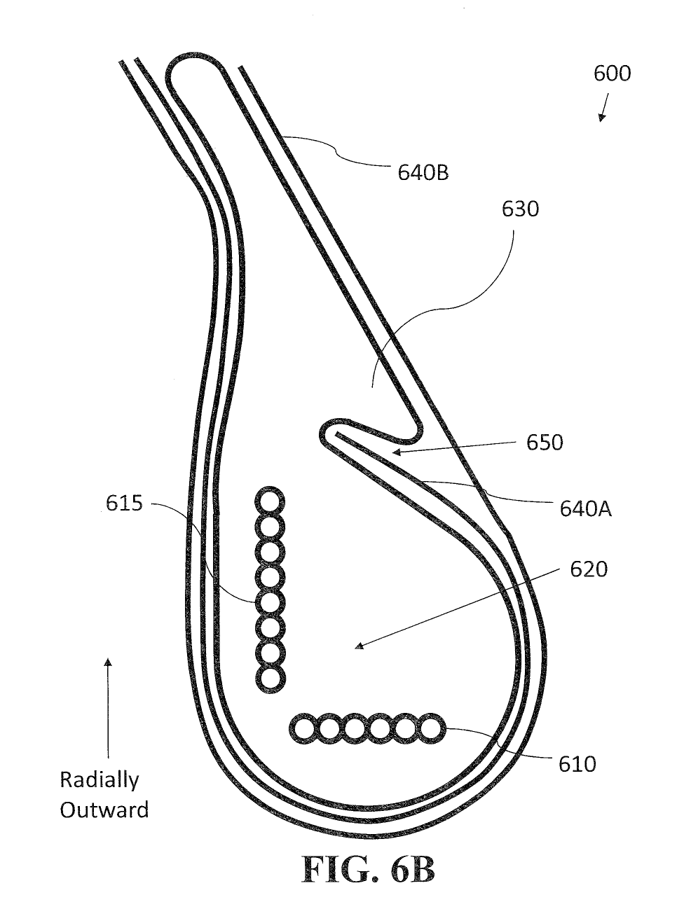

FIG. 6A illustrates a sectional view of an example arrangement of an over-molded bead 600. Bead wire 610 may be arranged in at least one linear array arrangement to form bead bundle 620. For example, bead wire 610 may be arranged in a horizontal linear array. Bead wire 615 may be arranged in a vertical linear array. Bead wires 610,615 may collectively form bead bundle 620 (as shown). Bead wires 610,615 may be arranged in any manner that meets the tire design requirements, such as, without limitation, strength, stiffness, hardness, weight, fatigue resistance, flexibility, heat resistance, cost, and the like. Bead filler 630 may be molded over bead bundle 620 to form over-molded bead 600. Bead filler 630 may at least substantially encapsulate bead bundle 620 within bead filler 630. Bead filler 630 may fully encapsulate bead bundle 620. Over-molded bead 600 may form a variety of shapes, such as the particular irregular shape as shown in FIG. 6. Over-molded bead 600 may include at least one cut-out 650 to allow the end of a body ply turnup (not shown) to nest within over-molded bead 600.

Alternatively, bead wires 610,615 may be oriented in any pattern disclosed herein, including in a grid array arrangement, circular array, and the like. Alternatively, bead wires 610,615 may be oriented in any traditional pattern.

FIG. 6B illustrates a sectional view of over-molded bead 600. Over-molded bead 600 may be at least partially surrounded by a first body ply 640A and a second body ply 640B. In one embodiment, an end of first body ply 640A may be oriented at least partially in cut-out 650. Second body ply 640B may be oriented about over-molded bead 600, and may extend radially outwardly past an end of first body ply 640A oriented at least partially in cut-out 650. Second body ply 640B may be oriented about over-molded bead 600, and may extend radially outwardly past cut-out 650. Second body ply 640B may be oriented about over-molded bead 600, and may extend radially outwardly past over-molded bead 600. Second body ply 640B may be oriented about over-molded bead 600, and may extend radially outwardly past cut-out 650 but may end radially inwardly of the radially outwardmost portion of over-molded bead 600.

Orientation of second body ply 640B along over-molded bead 600, while an end of first body ply 640A is oriented in cut-out 650 may allow second body ply 640B to extend about over-molded bead 600 at least one of: more smoothly; without an abrupt step at the point that second body ply 640B overtakes an end of first body ply 640A; and without creating a stress riser in second body ply 640B.

Bead wires 610,615 may be oriented as illustrated in FIG. 6B. Bead wires 610,615 may be oriented in any pattern disclosed herein, including in a grid array arrangement, circular array, and the like. Alternatively, bead wires 610,615 may be oriented in any traditional pattern.

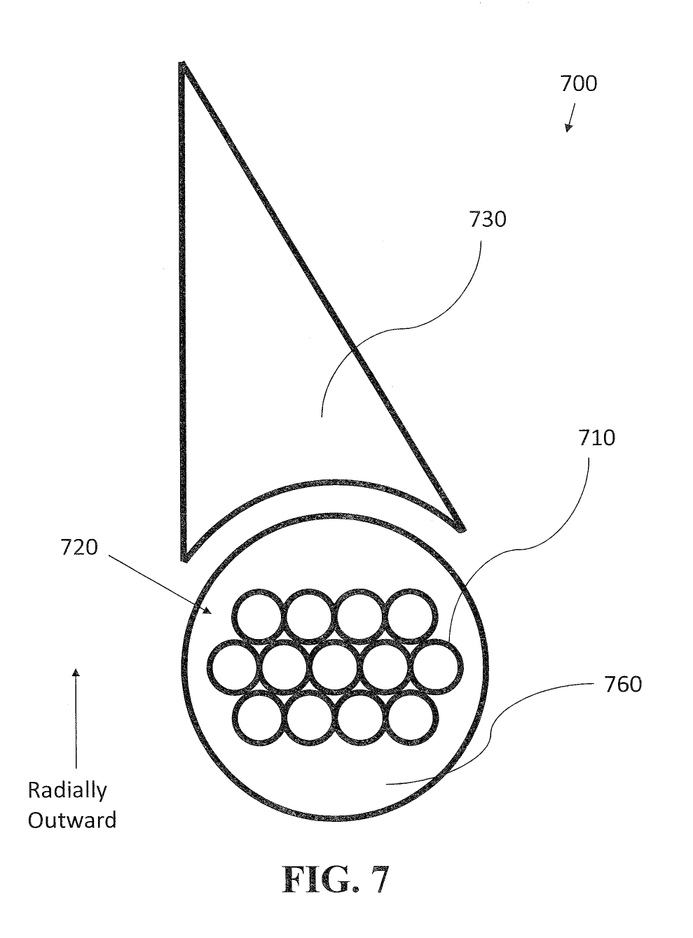

FIG. 7 illustrates a sectional view of an example arrangement of a two-piece over-molded bead 700. Bead wire 710 may be arranged in an offset grid-array arrangement to form bead bundle 720 (as shown). Bead wire 710 may be arranged in any manner that meets the tire design requirements, such as, without limitation, strength, stiffness, hardness, weight, fatigue resistance, flexibility, heat resistance, cost, and the like. Bead filler 730 may be molded separately from bead bundle 720. Bead filler 730 may form a variety of shapes, such as the particular wedge shape as shown in FIG. 7, a triangular shape, a square shape, a pentagonal shape, a hexagonal shape, and the like. Bead bundle 720 may have a polymer coating 760. Polymer coating 760 may be molded over bead bundle 720. Polymer coating 760 may have a variety of shapes, such as the particular circular shape as shown in FIG. 7, a triangular shape, a square shape, a pentagonal shape, a hexagonal shape, and the like. Bead filler 730 and polymer coating 760 may have complimentary shapes that allow each to nest together, forming two-piece over-molded bead 700. For example, the radially inward portion of bead filler 730 may have at least one surface with a particular radius of curvature. The radially outward portion of polymer coating 760 may have at least one surface with the same, or similar, radius of curvature, thus allowing polymer coating 760 to nest with bead filler 730 so as to collectively form two-piece over-molded bead 700.

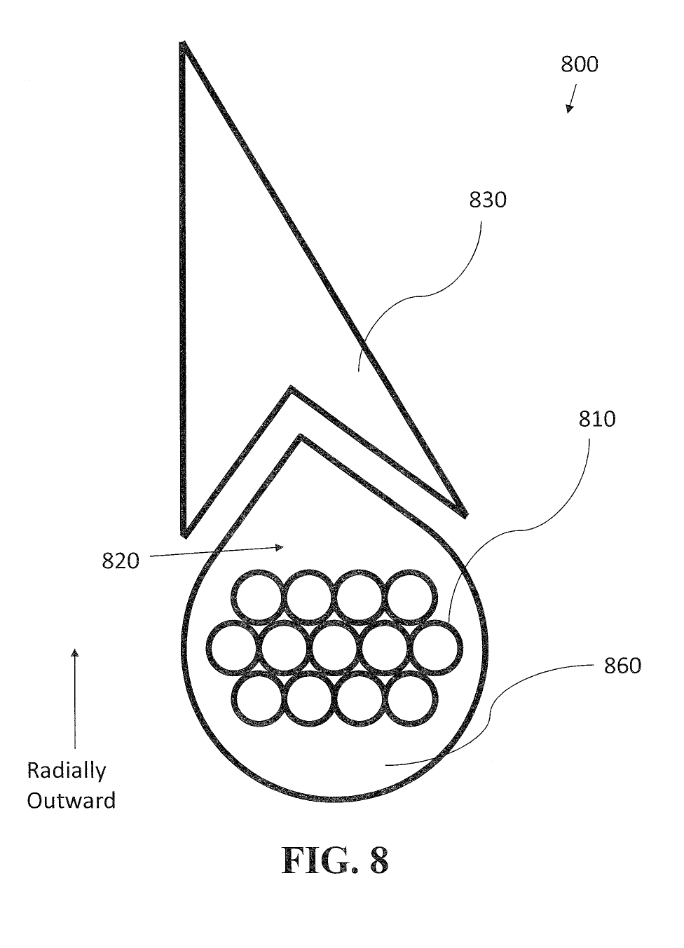

FIG. 8 illustrates a sectional view of an example arrangement of a two-piece over-molded bead 800. Bead wire 810 may be arranged in an offset grid-array arrangement to form bead bundle 820 (as shown). Bead wire 810 may be arranged in any manner that meets the tire design requirements, such as, without limitation, strength, stiffness, hardness, weight, fatigue resistance, flexibility, heat resistance, cost, and the like. Bead filler 830 may be molded separately from bead bundle 820. Bead filler 830 may form a variety of shapes, such as the particular wedge shape as shown in FIG. 8. Bead bundle 820 may have a polymer coating 860. Polymer coating 860 may be molded over bead bundle 820. Polymer coating 860 may also have a variety of shapes, such as the particular wedge shape as shown in FIG. 8. Bead filler 830 and polymer coating 860 may have complimentary shapes that allow each to nest together, forming two-piece over-molded bead 800. For example, the radially inward portion of bead filler 830 may have at least one surface having a particular angle. The radially outward portion of polymer coating 860 may have at least one surface with the same, or similar, angle, thus allowing polymer coating 860 to nest with bead filler 830 so as to collectively form two-piece over-molded bead 800.

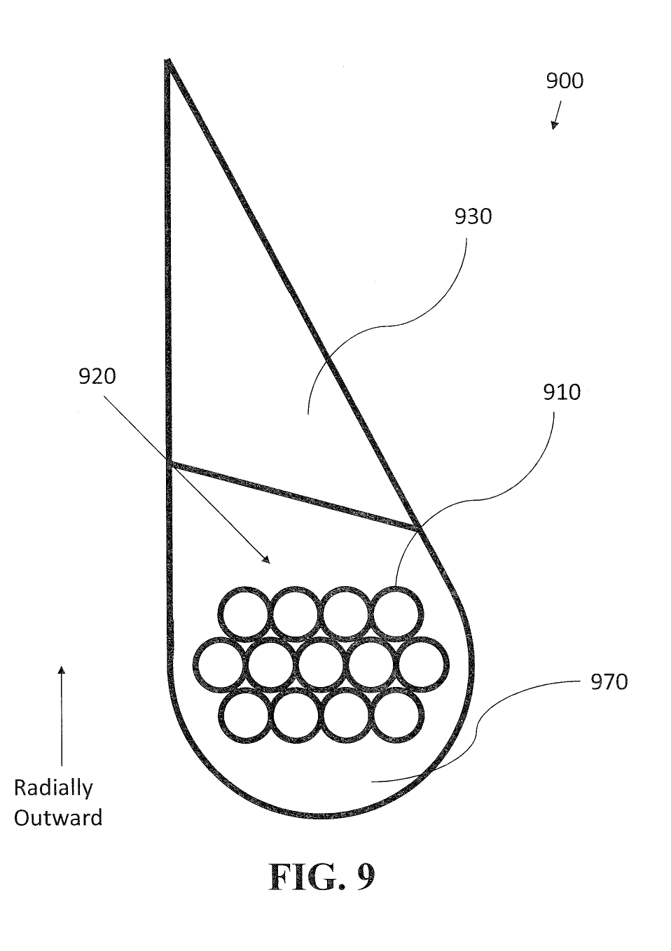

FIG. 9 illustrates a sectional view of an example arrangement of an over-molded bead 900. Bead wire 910 may be arranged in an offset grid-array arrangement to form bead bundle 920 (as shown). Bead wire 910 may be arranged in any manner that meets the tire design requirements, such as, without limitation, strength, stiffness, hardness, weight, fatigue resistance, flexibility, heat resistance, cost, and the like. Over-molded bead 900 may include more than one material. For example, over-molded bead 900 may include portion 930 made from one material and portion 970 made from another material. Portion 930 may have a hardness that the same as the hardness of portion 970. Portion 930 may have a hardness that is different from the hardness of portion 970. Over-molded bead 900 may include more than two materials, which may be distributed throughout over-molded bead 900 in various ways. For example, the exterior surface of over-molded bead 900 may be a different material from the interior volume of over-molded bead 900. Materials may vary across over-molded bead 900 either radially, axially, or in any combination thereof.

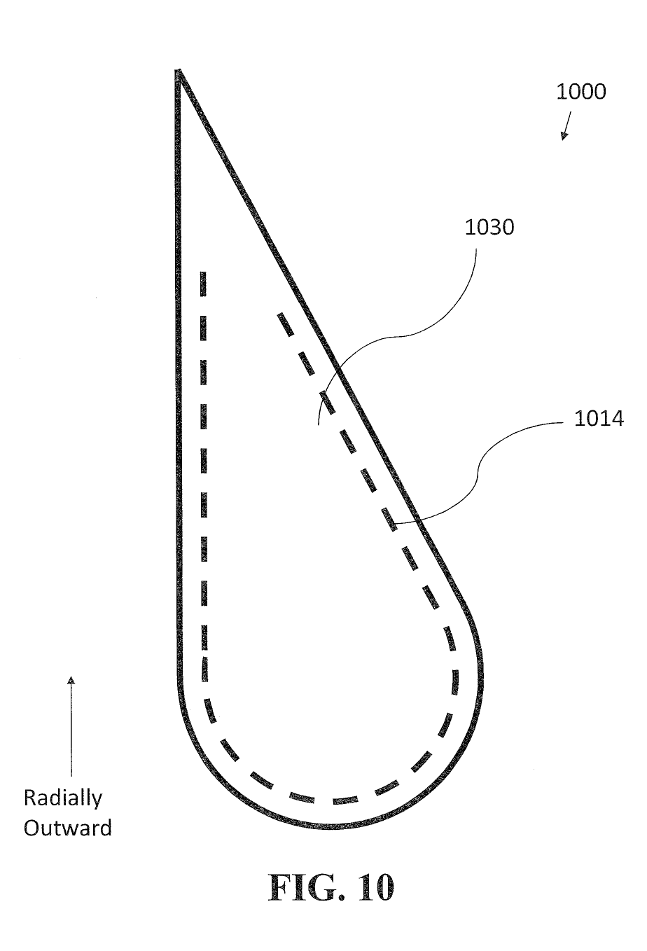

FIG. 10 illustrates a sectional view of an example arrangement of an over-molded bead 1000. Bead wire 1014 may be a fabric reinforcement, including without limitation, a nylon, a polyester, a rayon, an aramid fiber, a carbon fiber, a fiberglass, and the like. Bead filler 1030 may be molded over bead wire 1014, forming over-molded bead 1000. Bead wire 1014 may be arranged in any manner that meets the tire design requirements, such as, without limitation, strength, stiffness, hardness, weight, fatigue resistance, flexibility, heat resistance, cost, and the like. Over-molded bead 1000 may form a variety of shapes, such as the particular wedge shape as shown in FIG. 10.

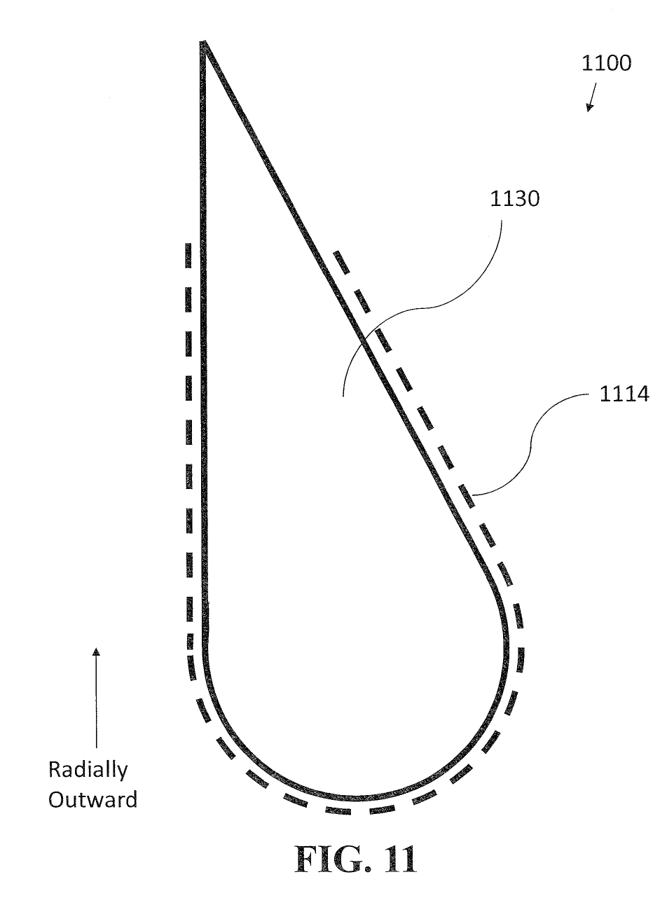

FIG. 11 illustrates a sectional view of an example arrangement of an over-molded bead 1100. Bead wire 1114 may be a fabric reinforcement, including without limitation, a nylon, a polyester, a rayon, an aramid fiber, a carbon fiber, a fiberglass, and the like. Bead filler 1130 may be molded such that bead wire 1114 is molded onto the exterior surface of bead filler 1130. Bead wire 1114 may be applied to the surface of bead filler 1130 after over-molded bead 1100 is molded. Bead wire 1114 may be arranged in any manner that meets the tire design requirements, such as, without limitation, strength, stiffness, hardness, weight, fatigue resistance, flexibility, heat resistance, cost, and the like. Bead wire 1114 may be oriented over at least a radially inner portion of bead filler 1130. Bead wire 1114 may be oriented over at least an axially inner portion of bead filler 1130. Bead wire 1114 may be oriented over at least an axially outer portion of bead filler 1130. Over-molded bead 1100 may form a variety of shapes, such as the particular wedge shape as shown in FIG. 11.

It is contemplated that any of the bead bundle shapes and/or bead wire orientations disclosed herein with respect to any particular figure may likewise be applied in an alternative arrangement to any other figure. That is, the bead bund shapes and/or bead wire orientations illustrated in each particular figure are not intended to be limiting, and it is contemplated that any shape and/or orientation illustrated or disclosed could be interchanged with another shape and/or orientation.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in the relevant manufacturing industry. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. An over-molded bead for a pneumatic tire, comprising:
a bead bundle comprising at least one of: a bead wire, a fabric reinforcement, and a polymer; and
a bead filler molded about the bead bundle so as to at least substantially encapsulate the bead bundle within the bead filler.

2. The over-molded bead of claim 1, wherein the molded bead filler fully encapsulates the bead bundle.

3. A bead for a pneumatic tire, comprising:
a bead bundle comprising at least one of: a bead wire, a fabric reinforcement, and a polymer; and
a molded bead filler,
wherein the outer surface of the radially inward portion of the molded bead filler is contoured to mate with the outer surface of the radially outward portion of the bead bundle.

4. The bead of claim 3, wherein at least one of the bead bundle and the molded bead filler are configured to be operatively connected to the other so as to collectively form an integrated unit.

5. The bead of claim 3, wherein the outer surface of the bead bundle and the outer surface of the molded bead filler further comprise at least one of a surface feature,
wherein the at least one surface feature comprises at least one of: a protrusion and an indentation; and
wherein the at least one surface feature of the bead bundle is configured to mate with the at least one surface feature of the molded bead filler.

6. The bead of claim 3, wherein the molded bead filler further comprises at least one surface feature, wherein the at least one surface feature includes at least one of: a dimple, an indentation, a ridge, a slit, a knurl, a cavity, a recess, a cut-out, and a step.

7. The bead of claim 3, wherein the molded bead filler comprises a polymer.

8. The bead of claim 3, wherein the molded bead filler comprises a polymer having a hardness of about 75 durometer or lower.

9. The bead of claim 3, wherein the molded bead filler comprises a polymer having a hardness of about 75 durometer or higher.

10. The bead of claim 3, wherein the molded bead filler further comprises a fabric reinforcement,
wherein the fabric reinforcement is oriented in at least one of: an interior of the molded bead filler and an exterior surface of the molded bead filler.

11. The bead of claim 3, wherein the bead bundle includes at least one of: a single bead wire, at least two adjacently-oriented bead wires, a plurality of bead wires arranged in a grid array, a plurality of bead wires arranged in an offset grid array, a plurality of bead wires arranged in a radial array, and a plurality of bead wires arranged in at least one linear array.

12. The bead of claim 3, wherein the bead wire includes at least one of: a bronze, a brass, a steel, a nylon, a polyester, a rayon, an aramid fiber, a carbon fiber, a fiberglass, and an alloy.

13. A bead for a pneumatic tire, comprising:
a bead bundle comprising at least one of: a bead wire, a fabric reinforcement, and a polymer; and
a bead filler molded about the bead bundle so as to at least substantially encapsulate the bead bundle within the bead filler.

14. The bead of claim 13, wherein the molded bead filler fully encapsulates the bead bundle.

15. The bead of claim 13, wherein the bead bundle includes a bead wire, wherein the bead wire is at least one of: molded onto an exterior surface of the molded bead filler and applied to the surface of the molded bead filler.

16. The bead of claim 13, wherein the molded bead filler further comprises at least one surface feature, wherein the at least one surface feature includes at least one of: a dimple, an indentation, a ridge, a slit, a knurl, a cavity, a recess, a cut-out, and a step.

17. The bead of claim 13, wherein the molded bead filler comprises a polymer.

18. The pneumatic tire of claim 13, wherein the molded bead filler further comprises a fabric reinforcement,
wherein the fabric reinforcement is oriented in at least one of: an interior of the molded bead filler and an exterior surface of the molded bead filler.

19. The pneumatic tire of claim 13, wherein the molded bead bundle includes at least one of: a single bead wire, at least two adjacently-oriented bead wires, a plurality of bead wires arranged in a grid array, a plurality of bead wires arranged in an offset grid array, a plurality of bead wires arranged in a radial array, and a plurality of bead wires arranged in at least one linear array.

20. The pneumatic tire of claim 13, wherein the bead wire includes at least one of: a bronze, a brass, a steel, a nylon, a polyester, a rayon, an aramid fiber, a carbon fiber, a fiberglass, and an alloy.
